(19) United States
(12) Patent Application Publication
(10) Pub. No.: US 2007/0198117 A1
(43) Pub. Date: Aug. 23, 2007

(54) Interactive custom design and building of toy vehicle

(76) Inventor: Nasir Wajihuddin, New York, NY (US)

Correspondence Address: Steven Horowitz;Counselor At Law, Suite 700, 295 Madison Avenue, New York, NY, 10017, US

(21) Appl. No.: 11/356,849

(22) Filed: Feb. 17, 2006

(51) Int. Cl. G06F 19/00

(52) U.S. Cl. 700/114

(57) ABSTRACT

A method and system for custom building a toy vehicle inside a store. A child makes design choices at a computer terminal inside the store that employs design software relating to a design of a toy car, the design software permitting design choices that trigger an ordering of components and an assembly of the toy car that simulates a real car assembly, the assembly commencing while the child interacts with the software and being completed within approximately a half hour of a first design choice. The assembly line located inside the store allows the child to dramatically see assembly of components and permits participating in the assembly by moving assembly objects to make design choices at component installation points. Design choices include style, model, color, front and rear ends, lights, doors, hood, height, wheels, engine, muffler, interior, spoiler, name and logo, and attachments.

### FIELD OF THE INVENTION

The field of this invention is toy vehicles, and more particularly, a method and system for an interactive custom design and building of a toy vehicle.

### BACKGROUND OF THE INVENTION AND DISCUSSION OF THE PRIOR ART

Children, especially boys, love cars and love to play with toy cars. This has both entertainment and educational dimensions. Although a multitude of different toy cars exist that young children play with, based on national market research survey data conducted among children between the ages of 7 and 14, there is an unfulfilled and deep need in young children, primarily young boys, for opportunities to display great creativity in relation to cars. There is also a deep need for opportunities to be able to interact with a car both in terms of the design of the car and in terms of the actual building of the toy car. Thus there is a need for the child to be involved creatively in the actual creation of toy vehicles.

With the advent and ubiquitousness of telecommunications, the computer and the Internet fewer services are provided in person and with a personal touch. There is a loss of the psychological impact involved in physically being present to see something happen. On the other hand, the computer allows visualization that cannot exist without a computer. It would be advantageous to have the benefits of the computer and also have at the same time the benefits of personal touch.

### SUMMARY OF THE PRESENT INVENTION

The present invention is a method and system for allowing a child of the age of approximately four to approximately 14 to interactively design and build a customized toy car that is approximately 6 to 10 inches long. The entire process takes place on site in an actual store. The method and system can be presented in different levels of sophistication depending upon the age of the child.

First, the child enters a retail store (such as a store in a mall) and designs the car on a computer by making selections on the computer. During (or right after) the design process the car already starts getting built. The designing and the building occur in the store. The total time for creating the customized car is approximately half an hour or less. The creation of the car occurs at an assembly line in the store that can be viewed by the child.

Based on software, the child enters personal data at the computer terminal in the store and begins making design choices. In an alternative embodiment, the child is at a computer terminal connected to the internet. In such a case, the computer terminal can be outside the store.

In a preferred embodiment, the child then selects the style of the vehicle, such as racing car, muscle car of the '60s, futuristic car, 1930s hot rod, etc. Then the child selects the model or brand of the car or vehicle. Then in one preferred embodiment he selects the color and decals, then he selects the front end and lights and then the rear end and lights. Then the child selects the door type (e.g. standard, suicide, gull wing, switchblade, etc), then in certain embodiments he chooses the width of the car. Then the child selects the height, the wheels, tires, the engine, the muffler, then the hood, then the interior (including seat belts and drivers), then the spoiler (an air deflector to prevent the car from lifting off the ground or to reduce drag). Finally, the child names the vehicle and chooses a logo in the front, chooses a registration and vanity plate, chooses attachments (overhead lights, cladding, running board, emergency lights) and accessories (including action figures in or around the car).

After the process of designing the car has begun by the child's selections at a terminal in the store, robots operating in an assembly line actually build the car. The operator at the store can control the speed of the assembly line. The child sees actual robotic arms picking up parts of the car and assembling them into a car, as well as painting and cutting parts of the car in the assembly line. In addition, there is bolting, welding using power tools. During the assembly process there is a paint shop and it uses non-hazardous paint applied in a non-hazardous manner. There is also a laser cutting operation for cutting the base plate (bottom of the chassis). The laser cutting operation has a theatrical effect. There are gravity chutes for sending wheels or other parts down. In certain embodiments, there are also AGV's (automated guided vehicles) for moving inventory around.

The child has the option to walk over to the assembly line and touch and move certain assembly line objects to thereby make additional design choices or substitute design choices of interesting items such as engine, doors and wheels.

Furthermore, the entire building process is designed to be interactive to maximize the child's enjoyment and identification with the product. For example, the child makes certain design choices at the computer and then actually sees with his own eyes these components being assembled into the car. More importantly, the child sees how these components are assembled into the car. The child then also makes additional design choices during the assembly by touching and feeling the components. For example, the child might pull a lever at the assembly line and a component slips down into place or a robotic hand slips down to install a component into place. Similarly, the child can touch a button at the assembly line and a laser which cuts the shape of the floor of the chassis, is activated or inactivated. Furthermore, by touching the tires or engine can thereby cause a particular style of tire or engine to be selected. The child therefore feels involved as the vehicle is being installed. Alternatively or in addition, the child can touch the components just before or after they are assembled.

### IMPORTANT OBJECTS AND ADVANTAGES

The following important objects and advantages of the present invention are:

(1) to provide a method and system for building a toy vehicle;

(2) to provide such a method and system wherein both the design and the building of the toy car occur in the same store;

(3) to provide such a method and system that is an enjoyable and stimulating experience for the child;

(4) to provide such a method and system that makes the child feel like he or she is participating in the building of the vehicle;

(5) to provide such a method and system that can fit inside stores having a multitude of differently shaped floor space;

(6) to provide such a method and system that in certain embodiments restricts the ability to reverse certain choices;

(7) to provide such a method and system wherein the child's time to make certain design choices can be accelerated;

(8) to provide such a method and system wherein design choices made by the child at a computer triggers ordering of components for the toy vehicle;

(9) to provide such a method and system that is educational for young children and in particular young boys;

(10) to provide such a method and system that is entertaining for young children and in particular young boys;

(11) to provide such a method and system that includes various theatrical effects to enhance the amusement and entertainment value;

(12) to provide such a method and system that can involve the child triggering a laser cutting operation by moving assembly line objects;

(13) to provide such a method and system that allows the child to physically walk over to an actual assembly line after making design choices and then making additional design choices at the point of installation on the assembly line;

(14) to provide such a method and system that involves the designing of a toy car both digitally and physically;

(15) to provide such a method and system that results in the child feeling that they really designed a real car;

(16) to provide such a method and system that results in the child genuinely feeling that he built a real car;

(17) to provide such a method and system that results in the child genuinely feeling that he purchased and owns a real car;

(18) to provide such a method and system that results in the child feeling that they are in a real factory containing a real assembly line;

(19) to provide such a method and system that provides opportunities for the child to further interact with the store in the future just like purchasers of real cars;

(20) to provide such a method and system wherein the child can see simultaneous side-by-side comparisons of the car incorporating competing design choices to make better choices that do not depend upon visualizing one design, keeping it in the child's “memory” and then choosing between a design they see and a design in the their memory;

(21) to provide such a method and system that offers the visualization benefits of the computer while also offering the personal touch of in person interactivity for the child;

(22) to provide such a method and system that allows the child to design and build a toy car that achieves certain performance characteristics (based on the design choices made) featured by the real car that the toy is a replica of;

(23) to provide such a method and system wherein the toy car can undergo testing.

### BRIEF DESCRIPTION OF THE DRAWINGS

FIG. 1 is a schematic of one preferred embodiment of the method and system of the present invention;

FIG. 2 is a schematic of a second preferred embodiment of the method and system of the present invention;

FIG. 3 is a perspective view of a child making design choices at a computer terminal to implement the method and system of the present invention; and

FIG. 4 is a fragmentary perspective view of a generic assembly line used in the method and system of the present invention.

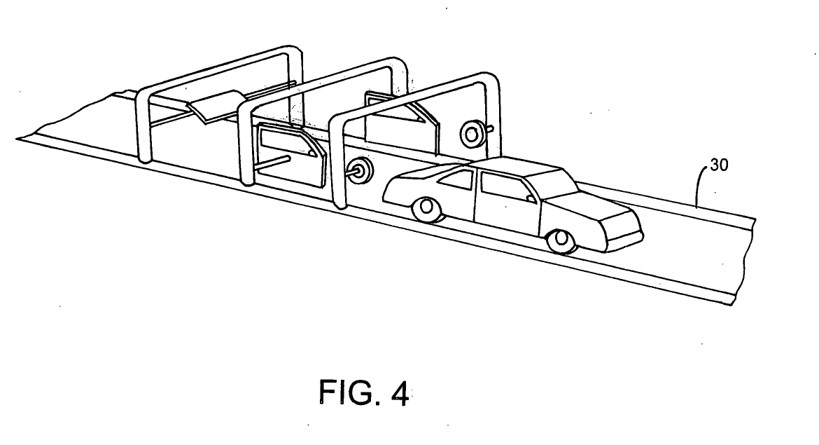

### DETAILED DESCRIPTION OF THE PREFERRED EMBODIMENT

The present invention is a method and system for allowing a child of the age of approximately four to approximately 14 to interactively design and build a customized toy car that is approximately 6 to 10 inches long. In certain embodiments, the toy car can be as long as approximately 20 inches or longer or can be less than 6 inches. The entire process takes place on site in an actual store. The method and system 10 can be presented in different levels of sophistication depending upon the age of the child. For children closer to age 14, the software would be at its maximum sophistication and would contain as many features as possible. For children closer to age 4 the software would be a younger version that leaves out design selections that relates to many details of the car. However, in all cases, the same assembly line would still build the car with all its parts. It is just that for much younger children there would be involvement in fewer components of the car in terms of design. In addition, a car for children below certain ages will meet legal and safety standards and may have fewer features.

In one broad summary of the method and/or system 10 of the present invention a computer input terminal 20 inside a store has an interactive design software that offers a series of design choices relating to a design of a toy car, the design software permitting a child to make design choices that trigger an ordering of components and an assembly of the toy car, this assembly commencing while or just after the child interacts with the software and is completed within approximately a half hour of a first design choice. The method and system further provides an assembly line 30 inside the store for the building of the toy car in the store wherein the child can see the assembly of components and can physically see how said components are assembled, the assembly line permitting a child to physically touch and move assembly line objects to make certain additional design choices or substitute design choices at an assembly installation point, the assembly line simulating an assembly line for a real car. The phrase “additional design choices” as used herein is broad enough to mean additional design choices and/or substitute design choices.

The assembly line in the present invention incorporates principles that are used in assembly lines for real cars. For example, the assembly is set up in a manner that maximizes its “uptime”. In particular, this is accomplished as follows:
having line as set of discrete sub-lines—so, if one station breaks down, employees can manually perform that operation, while keeping the remainder of the line in motion
preventive maintenance—scheduled for each location; each location gets preventive maintenance visit by technical people or mechanics
training of employees at location to fix machines, if they are down

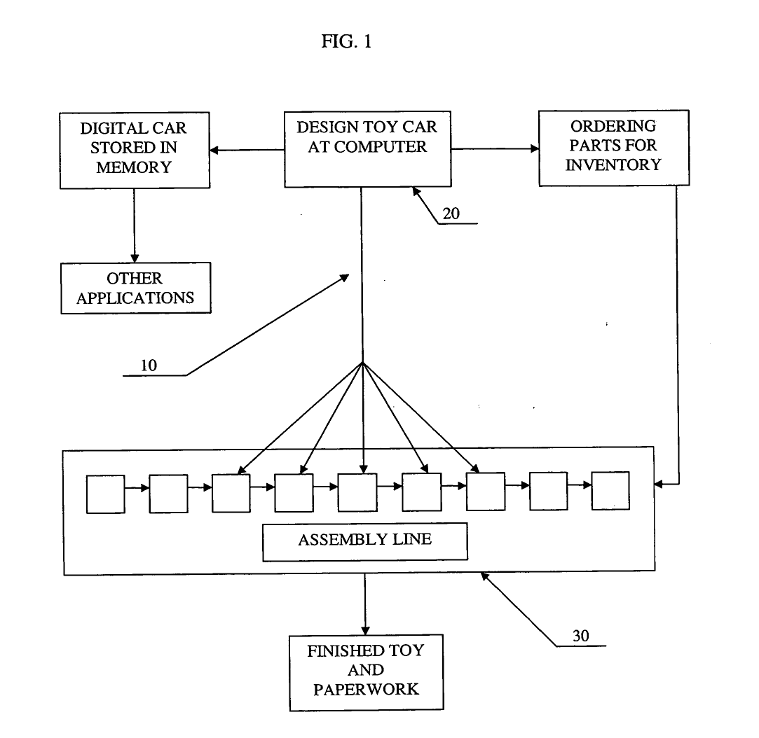

As seen in FIG. 1, the assembly line in the present invention interacts with the design selections that are made and the inventory and ordering of parts in response to the design choices that are made. Furthermore, it is an assembly line to build a toy car approximately eight inches long rather than a real car fifteen to twenty feet long. In addition, the line uses new principles not used in the assembly of real cars, e.g. building redundancy into the line (e.g., a parallel line—so, if one goes down, the other line is still running).

Although in FIG. 1 there are arrows from the box titled “Design Toy Car at Computer” to only certain points in the box depicting the assembly line, it should be clear that in accordance with the present invention the child can actually go to any and all points in the assembly line or he can go to fewer than all points in the assembly line. In addition, it should be clear that in accordance with the system and method of the present invention the child can skip points in the assembly line that are in the middle of the assembly line, not just at the beginning or the end of the assembly line.

In one preferred embodiment, there is more than one computer terminal containing the software used in the present invention so that more than child can making design choices for the building of more than one car at the same time in the same store.

The physical layout of the store determines or at least significantly affects the physical layout of the assembly line. Thus if the store's layout is long and narrow the assembly line must be long and narrow. Accordingly, one feature of the present invention is that although the parts of the assembly line are standardized in terms of the size and placement, the assembly line itself can accommodate a multiplicity of shapes. This is because the parts of the assembly line have standardized modular connections that allow the parts to be oriented in a variety of ways, as necessary to accommodate the physical layout of the store. So for example, the same system can be laid out in a linear fashion or in an L-shaped fashion. The assembly line can also be laid out in a circular pattern, a zig-zag configuration or any other configuration.

First, the child enters a retail store (in one embodiment such stores would be in a mall) and designs the car on a computer by making selections on the computer. In a preferred embodiment, during the design process the car already starts getting built. In an alternative embodiment, the car starts getting built right after the design process.

In either case, in a preferred embodiment, the designing and the building occur in the store. The total time for creating the customized car is approximately half an hour or less. The creation of the car occurs at an assembly line in the store that can be viewed by the child.

The use of the term “store” or “retail store” as used herein is intended to refer broadly to any physically location and it need not be an actual store. It can even be a mobile physical location such the back of a truck.

It should be noted that in an alternative embodiment, the cars does not start getting built until after the child completes the design process at the computer terminal.

Based on software that incorporates a simplified version of CAD/CAM drawings, the child enters personal data at the computer terminal in the store, then inputs design choices. In an alternative embodiment, the child inputs the design selections at a computer terminal connected to the internet. In such a case, the computer terminal can be outside the store.

Input from an “inventory module” affects the available design choices. A real-time inventory system keeps track of the inventory at the location, and locks out design choices that customer should not make since it would not be possible for the customer to have such a design manufactured. In addition, there is lock-out of certain parts—for example, if car has engine with a super-charger that would vertically jut out of the engine bay, car hoods are locked out unless the selected car hood has a large aperture to allow engine to jut out. In certain embodiments (e.g. designing remotely or over the Internet), where the customer is willing to accept a longer lead time that allows parts to be inventoried, then the lock-out features may not apply.

In one preferred embodiment, the child is advised that once they make certain design selections they cannot change their mind. However, in another preferred embodiment the child has some ability to reverse a choice—for example the child can go back one level of choice. In an alternative embodiment the child may be able to go back more than one level of choice. The reason for these restrictions is that once the design choice has been made the actual assembly of the car follows soon thereafter and that before the assembly can begin the parts needed for the assembly have to be ordered, and are in fact ordered. Ordering the parts means, in a preferred embodiment, that the parts physically arrive at the assembly line location from a near by location either located within the store or located out of the store. Another reason for having this restriction is to avoid blockages arising from a child not keeping an adequate pace in his or her design selections.

In certain preferred embodiments, the software has a built-in pace for design selection so that if the child does not make a design selection within an appropriate time (and in certain embodiments if there is a backlog as a result of that) then the computer software will make a design choice for them.

There is a series of design selections that the child makes for the physical make-up of the toy car. In a preferred embodiment, with each or most of the design selections there is also triggered an opportunity for the child to assess the performance characteristics of a vehicle that incorporates that design choice. Examples are provided below.

When we speak about the performance characteristics of a toy car, we are really speaking about the performance characteristics of the real car that the toy is supposed to be a replica of. These characteristics can include—the no. of miles per gallon, the ability to achieve a certain speed. The performance characteristics are a function of certain design choices, like the selection of the spoiler, the tires, the type of engine, and the ground clearance. Thus, the method and system of the present invention allows a child to design and build a car that achieves certain performance characteristics. This also includes the performance characteristics of the features that the child chooses to incorporate in the vehicle at the “imagination station” referred to below.

In a preferred embodiment, the child then selects the style of the vehicle, such as racing car, muscle car of the '60s, futuristic car, 1930s hot rod, etc. Then the child selects the model or brand of the car or vehicle. The child, in a preferred embodiment, then selects the color of the vehicle and the application, if any, of decals. The decal placement operation could be automated or it can be conducted by human workers. The level of participation by the child in the decal placement operation can vary.

In one preferred embodiment, the next design choice is that the child selects the front end and lights and then the rear end and lights. With respect to lights there can be different fog lights, colored underbody lights, interior lights, strips of lights on the side of the car. These lights can have a variety of colors and a variety of flashing sequences.

In a preferred embodiment, the child then selects the door type (e.g. standard, suicide, gull wing, switchblade, etc). Then in certain embodiments he chooses the width of the car.

In one preferred embodiment, the child then selects the hood, the height, the wheels, tires with different tread patterns, the engine (for example, V8, hybrid, super-charged, nitrous oxide system), the muffler, then the interior. In certain embodiments, the child may choose a sound chip that contains an audio of how the car will sound based on its engine.

With respect to the interior of the car, it is noted that the interior can includes seats, dashboard, gear shifter, seat belts, and other components. It also includes color, materials and style/design options.

With respect to the selection of the battery; circuits/circuit board, lights, horns, alarms, insulation, the child can observe how these parts are integrated into the body of the car. In a preferred embodiment, the child can also audio test components to have more information in make choices.

Near the end of the design choices, the child chooses the spoiler (an air deflector to prevent the car from lifting off the ground). With respect to the spoiler, the software incorporates a virtual wind tunnel that allows the child to set the aerodynamics. For example, the impact of different types of spoilers or the impact of different angles that spoilers are set at can be viewed and then selected. Both on the computer and at the assembly line, the drag can be tested based on a particular setting of the angle of the spoiler with a visualization demonstration involving air/smoke.

As part of the assembly line, there is an “imagination station” wherein the child, by moving assembly line objects can design a flying car by adding wings, or can design a special security car by adding security features, or can incorporate childhood action figures into the car as passengers or otherwise. Furthermore, the child can select different wing configurations, different space travel engines, armor, ray guns etc.

Body mating (placement of the body of the car into rest of the car) may be a separate sub-assembly that is in adjacent area. In one preferred embodiment, car bodies that have already been colored (e.g., black, red, blue), are matched to parts that have also been colored, that customer wants to have put on bodies. In an alternative embodiment, the body and/or parts are paintable. Body and/or parts flow into paint station which uses UV or other technology to rapidly cure paint and has air suction/dissipation and other safety processes or the body and/or parts are covered by decals. In a further alternative embodiment, the child has both of these two options—the one in the preferred embodiment and the one in the alternative embodiment. In a further preferred embodiment, there is an electroplating operation for some parts e.g., bumpers and logos.

The software and/or assembly line also permits the child to select that the toy vehicle will undergo a car wash.

Finally, the child names the vehicle and chooses a logo in the front, chooses a registration and vanity plate, chooses attachments (overhead lights, cladding, running board, emergency lights) and accessories. The child can also be provided with an owners' manual (in CD and/or online version). In one preferred embodiment, other paperwork and details are provided to the child to simulate the real world experience of purchasing a car. For example, a Vin number and a manifest or window sticker may be provided. This information is stored as part of the customer profile information. This data is generated to keep track of the car and its customer association.

In some embodiments, a customer (i.e. the child) and car profile can be generated from information supplied by the child at the retail store, and by details on toy car created by/for the child and accessories purchased by/for the child.

In a preferred embodiment, the child has the ability to conduct testing on the car. The child can test the electronics (lights, sounds), the alignment, the horsepower (even though the horsepower is only theoretical since it is a non-working engines). A quality report is generated in certain preferred embodiments.

When the toy car is ready for provision to the child, in a preferred embodiment it simply rolls off the assembly line and the child takes it. Then the keys to the toy car are handed to the child along with the other papers of ownership. In one preferred embodiment, on or about the point of transfer of the physical car to the child, individuals cheer and/or clap or else a taped sound of cheering/clapping is played.

The software itself generates prompts for the design choice to be made at each step of the design process. Thus, the design software places on the screen a list of different types of a particular component and asks for the child to select one of the choices for that car component. The software allows the child to visualize what would the car look like if the child selects each choice.

Although in one preferred embodiment, the design selection choices that have been listed above occur in that particular order, in other preferred embodiments, the actual order of the above choices may vary somewhat or a great deal. The only limitation of the order is that the selection of a part that presupposes the existence of another part should come after the other part has been selected. Furthermore, particular design choices can be eliminated and it is certainly contemplated by the present invention that fewer than all of the design choices can be used or some additional choices added.

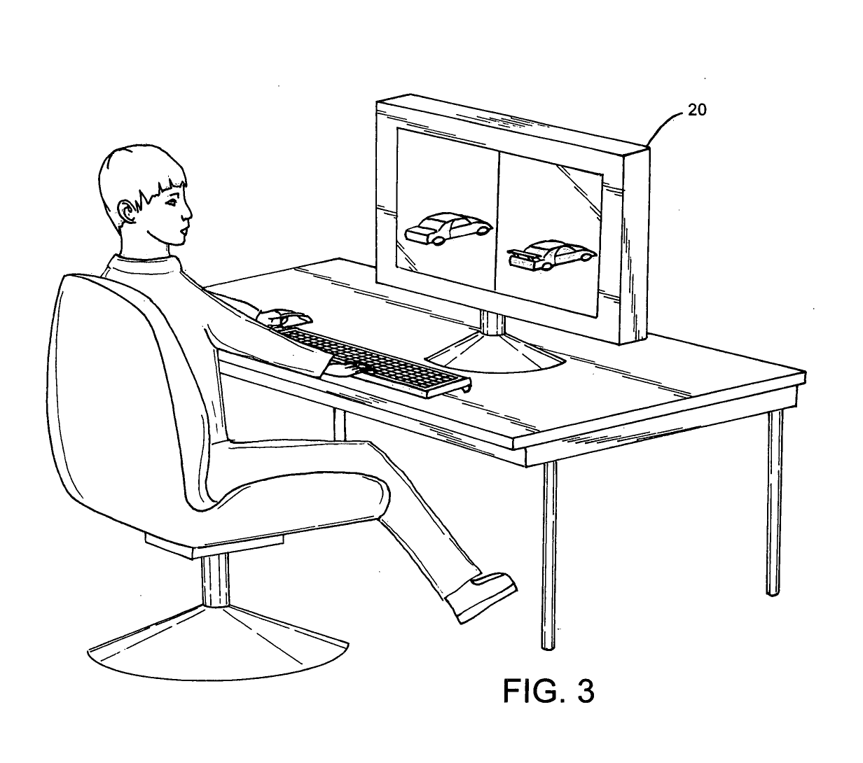

In a preferred embodiment, the method and system of the present invention also includes displaying an image of a car incorporating the design choices at each step of a design process and permitting simultaneous viewing of different cars incorporating different design choices for a particular component. Thus not only does the software cause the design choices to permit instant visualization of in progress vehicle having the new design choice plus the previously selected choices, but the software permits the child to simultaneously see on a single screen a multitude of vehicles each having a different design selection for a particular component. Thus the software features more than one view (or side by side comparison) on screen of different choices i.e., customer can see visual of their design with side by side comparison of more than “one” design. This side-by-side comparison of competing designs enables customer to make better choices rather than simply visualizing one design, keeping it in their “memory” and then choosing between a design they see and a design in the their memory. This is illustrated in FIG. 3 which shows a child making design choices by viewing a side by side comparison of toy cars one of which has a spoiler and the other of which does not.

In a preferred embodiment, the design selection system that the child interacts on the computer with may itself offer suggestions at some or all of the design selection junctures. After the process of designing the car has begun by the child's selections at a terminal in the store, robots, robotic arms or human workers operating in an assembly line actually build the car.

The operator can control the speed of the assembly line—slower or faster. In addition, the system may make adjustments in the speed based on the customer traffic. For example, when a particular location is busy, the assembly line can be sped up to increase customer throughput. Conversely, when a location is slow, it can slow the speed down to create an impression of being busy.

The child sees actual robotic arms picking up parts of the car and assembling them into a car, as well as painting and cutting parts of the car in the assembly line. In addition, there is bolting, welding using power tools. During the assembly process there is a paint shop where you paint the body of the car. It uses non-hazardous paint applied in a non-hazardous manner. Alternatively, you have already painted bodies with various colors.

There is also a laser cutting operation for cutting the base plate (which is at the bottom of the chassis) to the right size. The laser cutting operation can be real or it can merely be a simulated laser-cutting operation for a theatrical effect.

Other theatrical effects exist. For example, there are gravity chutes for sending wheels or other parts down the chute and into position for a robot to install the component. The child triggers it by moving an assembly object. The assembly line also includes overhead conveyors, in addition to other mechanisms, to transport inventory to specific locations for specific assembly line operations. This all occurs in the store.

After a certain number of design choices have been made, including the style and model of the car, the child can make other design choices involving the selection of a particular component, for example, the engine, doors, wheels, or other interesting car components, at the actual location where that component is to be installed. By touching and moving assembly line objects such as levers, buttons, joy sticks, triggers, and other interactive devices at various stations along the assembly line, the child thereby activates certain processes and physically participates in the assembly of the car and the design of the car at the assembly point. This enhances the feeling of participation and the enjoyment enormously.

The software also provides output of the design choices of the child to a “demand analysis” module. This module allows analysis of customer desires, and is used for ordering new inventory or planning new types of designs.

The assembly process is structured so that some of the design choices occur near the actual point of the assembly line where that part is to be assembled and installed. This serves to increase the feelings of participation and involvement by the child in the building process. For example, if the assembly line is fifty feet long and the 40 foot point is where the wheels are assembled, then the design choices associated with the selection of the wheels occur just before or near the point in the assembly line where the wheels are installed into the car. The child has the ability to make design choices relating to the wheels that were not previously made on the computer or else to actually reverse a previously made choice and substitute a different design choice.

Similarly, the selection of the engine should be timed so that it occurs soon before the engine is installed on the assembly line. Furthermore, the entire building process is designed to be interactive to maximize the child's enjoyment and identification with the product. For example, the child makes certain design choices at the computer and then actually sees with his own eyes these components being assembled into the car. More importantly, the child sees how these components are assembled into the car. The child then also makes additional design choices during the assembly by touching and/or seeing the components. For example, with respect to the drive train, i.e. the shocks, axles, brakes, wheels and tires, the child's design choices are also located at the point on the assembly line where these components are installed.

The child can further participate by pulling trigger/pushing buttons to operate “tools” e.g., installing bolts using power drills, or checking a tire's air pressure using a pressure gauge. The child might pull a lever at the assembly line and a component slips down into place or a robotic hand slips down to install a component into place. Similarly, the child can touch a button at the assembly line and a laser which cuts the shape of the floor of the chassis, is activated or inactivated. Furthermore, by touching the tires or engine can thereby cause a particular style of tire or engine to be selected. The child therefore feels involved as the vehicle is being installed. Alternatively or in addition, the child can touch the components just after they are assembled.

Because of the fact that things look different in the real world even as compared to a 3D image on a computer, components of the toy car can be made available at stations along the assembly line for the child to pick up and feel in order to make the relevant design choice. For example, a small engine can be located at the point in the assembly line where the engine is installed for the child to pick up and feel.

The entire operation is designed to be applicable to a retail operation of any shaped store since the assembly line is modular and can be shaped to suit a long and narrow store or a wide and short store. To prevent breakdown there is redundancy built into the system, i.e. parallel tracks.

The process is not only customized and interactive but also has important educational aspects. For example, at various stations in the assembly line and/or at various points in the design process within the software, educational content can be inserted to explain the process, the product and the design choices. This educational material can be provided via video loops, interactive kiosks and/or signage.

As can be seen from the following outline, the method and system of the present invention genuinely makes the young child feel like they have designed and built and own a real car. The fact that in reality it is a toy car and not a real car is in effect not noticed or at least comes to be psychologically irrelevant to the child.

One feature of the operation is material resource planning, which means if inventory is low or running out, then that design choice is automatically eliminated by the software. In order to achieve this, real time information on inventory levels of individual parts at station locations is fed into the design CAD/CAM system (with CAD/CAM locking out design choices for which there is no inventory), and is fed into demand analysis and inventory ordering systems.

Another feature is that the system can speed consumers through at peak hours by speeding up the entire assembly line or a portion of the assembly line.

Another feature is that in order to make the system work at an optimum level, in one preferred embodiment, there is a high degree of common/modular parts. This is necessary to keep inventory down while creating high level of perceived consumer choices via mix and match approach. So, for example the “nose cone” component can fit into multiple car designs or models, as can “a winged spoiler”, “lights”, “engine hood” and “interior”. “Quick customization” may be made available for customers with limited time or for customers who may not wish to repeat the entire experience and may wish to bypass certain operations.

In one embodiment, the child can bypass multiple operations to reduce time. This is for the child who wants shortened experience (partially built cars at different points in the factory).

In an alternative embodiment of the present invention, the designing part occurs with the child at home interacting on a computer with a web site on the Internet and then comes in to get the car (or has it shipped). This alternative embodiment is not as desirable as the preferred embodiment and loses an important amount of personal touch but it can still provide a lot of satisfaction to the child.

Although the present invention has been described in terms of cars, it is certainly contemplated that it is equally applicable to other toy vehicles, including but not limited to toy boats, toy airplanes, toy trucks, toy motor cycles etc.

Furthermore, the present invention can be extended in other respects too. For example, 3D car/accessories can be translated into a “digital version” for use in PC games and online activities. The digital car is similar to or has likeness of the 3D car built at location. Information would be stored in a database for access by the child.

Another extension of the present invention is the ability to take the car that he designed and use it in other contexts, such as video games or PC games including on the World Wide Web. The child conducts digital activities with the digital car (which, as indicated, is in itself based on the 3D car). These digital car/accessories serve as the basis for, or support of, these digital activities. Results of these digital activities are stored in a database. For example, the child takes the digital car and then (typically from home or outside of the store) “enhances” this car by adding more detail, more parts or more capabilities into the digital car. This enhancement is based on content available from a digital resource such as a website and greatly contributes to a deeper knowledge about the car product. Alternatively, the child takes the image of the digital car and stores it in their computer or puts it on their personal web pages for access by others. Alternatively, the child participates in a digital game where they race the digital car and based on their race performance they accrue bonus points.

The child can also make modifications to the digital car out of the store (remotely) and then go in to the store to pick up the modified 3D car.

The present invention also contemplates connecting digital activities or digital car back to a physical location—the retail store. The child's digital activities are the optional basis for or support of building a new car, buying accessories or modifying an existing 3D car at the location. For example, the digitally enhanced version is produced either in its entirety or partially at location—so, if the child had enhanced their digital version with a super-charger for extra engine power, the 3D version comes equipped with a super-charger. Alternatively, the child comes to the location and redeems their bonus points accrued from e.g., online gaming successes in exchange for car parts or for a discount on their new 3D car.

Another optional aspect of the present invention is that when the assembly line in the retail store is shut down because of no customers at the time or because of down time, there is provided a motion-visual of cars being assembled (much like a toy train set). A toy car or a partially finished toy car would be put on a track and made to move along it like a toy train set moving to generate an impression of an assembly line having motion.

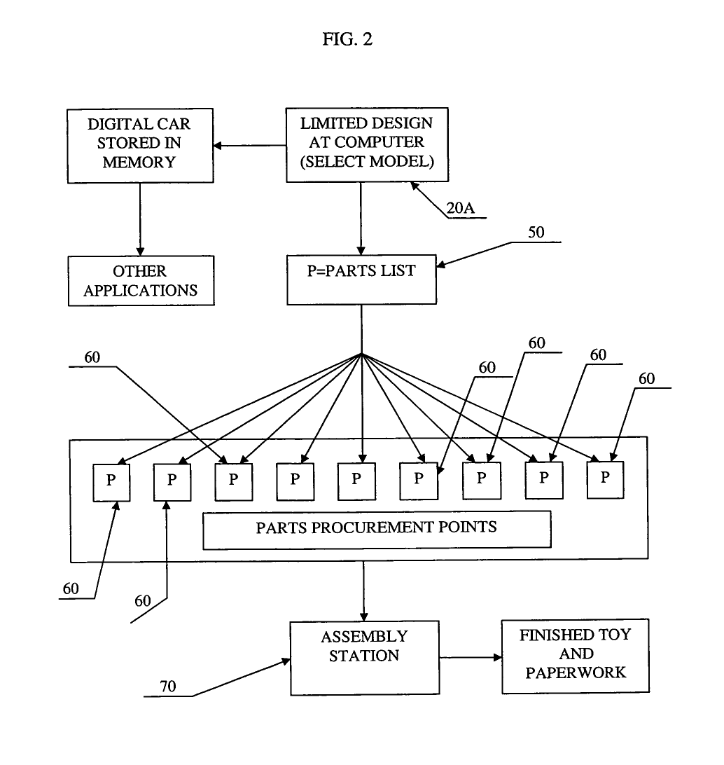

In an alternative preferred embodiment to the present invention shown in FIG. 2 that is considered inferior, the child does not design most of the car by the computer in the store but rather starts the process by entering the model of the car and other basic limited design information about the car on the computer 20a to select the design of the car. The computer printer will then generate “information” i.e., a blueprint or picture of the car and a parts list 50—a printout of the parts needed for that model. Alternatively, this printout of parts can be made available via computer or television monitors available at various points in the store where the parts are located. The child then walks to a parts procurement location 60 corresponding to each of these parts in the parts list, within the store, and selects various the parts of the car. The child then walks over to an assembly station 70 in the store where the car is assembled with the components he selected. Thus there is no assembly line. When the child approaches the parts procurement location for each part, the child need not use the exact part listed in the parts list. Instead, the child has the option to substitute these parts with other parts at each parts location as he picks up the parts, e.g., wheels with raised white letters over wheels that did not have such letters

In this embodiment, there are limited design choices made on the computer, just enough to establish the style, model and brand of the car. Accordingly, the design selection process on the computer does not necessarily trigger any ordering of inventory.

In another alternative version for this alternative embodiment, the blueprint may not provide a complete list of the parts—and child has to make choice of some parts by looking at them.

The child takes the parts to an assembly station or a set of assembly stations. Here the parts are used to build the car. The building of the car itself will generally be carried out by a location employee, with some assistance/input from the child. The building of the car will use tools such as power screw drivers, cutters, and drills. The child, depending on their age and suitability, will be exposed to these tools. In a further alternative embodiment, there are multiple assembly stations for servicing multiple children.

In this embodiment, certain portions of the car, for example, the body of the car or decaling, may be prepared in advance and be in place when the child reaches the assembly station.

In this embodiment, there will be a way to test the quality of the built car and a way to test if the car performs its functions as designed. For example, whether the lights works, whether the wheels have been installed in a manner that they don't fall off—they could be tested by gravity being used and car being sent down a down ramp with ridges and bumps to test if they have been properly installed.

In one alternative embodiment of the present invention that is expected to be even more inferior, the design step is completely eliminated and the child starts the process by simply selecting parts of the car and then taking the selected components over to the assembly station to obtain a car based on the car components he or she selected. The parts procurement points may be divided into sections to make it possible for the child to know where to go to get all the necessary parts for the car.

It is to be understood that while the method and system of this invention have been described and illustrated in detail, the above-described embodiments are simply illustrative of the principles of the invention. It is to be understood also that various other modifications and changes may be devised by those skilled in the art which will embody the principles of the invention and fall within the spirit and scope thereof. It is not desired to limit the invention to the exact construction and operation shown and described. The spirit and scope of this invention are limited only by the spirit and scope of the following claims.

What is claimed is:

1. A method of building a toy vehicle, comprising:
providing a computer input terminal inside a store having an interactive design software that offers a series of design choices relating to a design of a toy car,
the design software permitting a child makes design choices to trigger an ordering of components and an assembly of the toy car, said assembly commencing while after the child interacts with the software and being completed within approximately a half hour of a first design choice,
providing an assembly line inside the store for the building of the toy car in the store wherein the child can see the assembly of components and can physically see how said components are assembled,
the assembly line permitting a child to physically touch and move assembly line objects to make certain additional design choices at an assembly installation point,
the assembly line simulating an assembly line for a real car.

2. The method of claim 1, wherein the design choices include a style of the vehicle, a model, a color and decals, a front end, front end lights, a rear end, rear end lights, a door type, a hood, a height, a wheels, an engine, a muffler, an interior, a spoiler, a name and logo, a registration and vanity plate.

3. The method of claim 1, wherein the assembly including bolting, welding and painting using non-toxic paint.

4. The method of claim 1, wherein the speed of the assembly line can be controlled.

5. The method of claim 1, wherein the design choices include selection of the engine, wheels and/or doors.

6. The method of claim 1, including displaying an image of a car incorporating the design choices at each step of a design process and permitting simultaneous viewing of different cars incorporating different design choices for a particular component.

7. The method of claim 1, wherein providing an assembly line means providing an assembly line that includes an imagination station.

8. The method of claim 1, wherein the child is provided with an ownership manual after the car is completed.

9. The method of claim 1, wherein a digital car is stored by the design software for use in other digital applications such as video games.

10. The method of claim 9, design changes to the digital car can be made from outside the store and then the child can go to the store to pick up a modified car pursuant to the design changes.

11. The method of claim 1, wherein the toy car has associated therewith certain performance characteristics.

12. The method of claim 1, wherein said assembly commences just after the child interacts with the software and not while the child interacts with the software.

13. The method of claim 1, wherein the child's design choices can be restricted based on an availability of inventory.

14. A system for custom building a toy vehicle, comprising:
a computer input terminal inside a store having an interactive design software that offers a series of design choices relating to a design of a toy car,
the design software permitting a child makes design choices to trigger an ordering of components and an assembly of the toy car, said assembly commencing while the child interacts with the software and being completed within approximately a half hour of a first design choice,
an assembly line inside the store for the building of the toy car in the store wherein the child can see the assembly of components and can physically see how said components are assembled,
the assembly line permitting a child to physically touch and move assembly line objects to make certain additional design choices at an assembly installation point,
the assembly line simulating an assembly line of a real car.

15. The system of claim 14, wherein the design choices include a style of the vehicle, a model, a color and decals, a front end, front end lights, a rear end, rear end lights, a door type, a hood, a height, a wheels, an engine, a muffler, an interior, a spoiler, a name and logo, a registration and vanity plate.

16. The system of claim 14, wherein the assembly including bolting, welding and painting using non-toxic paint.

17. The system of claim 14, wherein the speed of the assembly line can be controlled.

18. The system of claim 14, wherein the design choices include selection of the engine, wheels and/or doors.

19. The system of claim 14, including displaying an image of a car incorporating the design choices at each step of a design process and permitting simultaneous viewing of different cars incorporating different design choices for a particular component.

20. The system of claim 14, wherein providing an assembly line means providing an assembly line that includes an imagination station.

21. The system of claim 14, wherein the child is provided with an ownership manual after the car is completed.

22. The system of claim 14, wherein a digital car is stored by the design software for use in other digital applications such as video games.

23. The system of claim 22, design changes to the digital car can be made from outside the store and then the child can go to the store to pick up a modified car pursuant to the design changes.

24. The system of claim 14, wherein the toy car has associated therewith certain performance characteristics.

25. The system of claim 14, wherein said assembly commences just after the child interacts with the software and not while the child interacts with the software.

26. The system of claim 14, wherein the child's design choices can be restricted based on an availability of inventory.

27. A system for custom building a toy vehicle, comprising:
a computer input terminal inside a store having an interactive design software that offers a series of limited design choices to a child relating to a design of a toy car and that generates a parts list based on the design choices made,
a series of parts procurements points inside the store wherein a child can collect parts on the parts list,
an assembly station for receiving the parts from the parts list from the child and for assembling the car by the use of humans, wherein the child can see the assembly of components and can physically see how said components are assembled.

28. The system of claim 27, wherein the parts list includes, a front end, front end lights, a rear end, rear end lights, doors, a hood, wheels, an engine, a muffler, an interior, a spoiler, a name and logo.

29. The system of claim 27, wherein the assembly station assembles the car using bolting, welding and painting using non-toxic paint.

30. The system of claim 27, wherein the child participates in the assembly of the car by the humans.

31. The system of claim 27, wherein the child is provided with an ownership manual after the car is completed.

32. The system of claim 27, wherein a digital car is stored by the design software for use in other digital applications such as video games.

33. The system of claim 28, design changes to the digital car can be made from outside the store and then the child can go to the store to pick up a modified car pursuant to the design changes.

34. The system of claim 27, wherein the toy car has associated therewith certain performance characteristics.

35. The system of claim 27, wherein said assembly commences just after the child interacts with the software and not while the child interacts with the software.
